(19) United States
(12) Patent Application Publication
(10) Pub. No.: US 2008/0167050 A1
(43) Pub. Date: Jul. 10, 2008

(54) METHOD AND SYSTEM FOR MANAGING USER PREFERENCES FOR ONE OR MORE SOFTWARE APPLICATIONS RUNING ON A MOBILE COMPUTING DEVICE

(75) Inventors: Christopher M. Songer, Louisville, KY (US); Patrick C. Lankswert, Louisville, KY (US); Ahmad J. Mirani, New Albany, IN (US); Milamaria S. Songer, Louisville, KY (US)

Correspondence Address: STITES & HARBISON, PLLC, 400 W MARKET ST, SUITE 1800, LOUISVILLE, KY, 40202-3352, US

(73) Assignee: STONESTREET ONE, INC., Louisville, KY (US)

(21) Appl. No.: 11/969,292

(22) Filed: Jan. 4, 2008

Related U.S. Application Data
(60) Provisional application No. 60/883,622, filed on Jan. 5, 2007.

(51) Int. Cl. H04Q 7/20

(52) U.S. Cl. 455/456.3

(57) ABSTRACT

A computer-based method and system for managing user preferences for one or more software applications running on a mobile computing device comprises the steps of: using the mobile computing device to receive data concerning a location of the mobile computing device; using the mobile computing device to receive data about each wireless device present and/or available for connection in the location; querying a first database to ascertain optimal user preferences for the one or more software applications running on the mobile computing device based on the location of the mobile computing device and the wireless devices present and/or available for connection in the location; and communicating instructions to one or more software applications for changing the user preferences associated with each software application to the optimal user preferences.

### CROSS-REFERENCE TO RELATED APPLICATIONS

The present application claims priority to U.S. Provisional Patent Application Ser. No. 60/883,622 filed on Jan. 5, 2007, the entire disclosure of which is incorporated herein by reference.

### BACKGROUND OF THE INVENTION

The present invention is a computer-based method and system for managing user preferences for one or more software applications running on a mobile computing device.

Mobile computing devices, such as laptop computers, personal data assistants (PDAs) and pocket computers, are commonly transported from one location to location. Such mobile computing devices are increasingly provided with wireless networking capabilities, allowing the mobile computing devices to look for and connect to wireless devices and networks as they are transported from one location to another location. For example, a user can carry a laptop computer into a new environment, access a local network, and then move files between computing devices or print to available network printers. However, there remain some barriers to efficient operation of mobile computing devices as they transition from one location to another. For example, network settings on the mobile computing device may need to be changed depending on the location, or the default printer may be set for one location, while the user has moved to another location.

In short, there remains a need for effective management of user preferences as a mobile computing device is transported from one location to location.

### SUMMARY OF THE INVENTION

The present invention is a computer-based method and system for managing user preferences for one or more software applications running on a mobile computing device.

A exemplary method for managing user preferences for one or more software applications running on a mobile computing device commences with the mobile computing device receiving data concerning its location. The mobile computing device further receives data from one or more wireless devices present and/or available for connection in the location. The next step is to query a first database to ascertain optimal user preferences for one or more software applications running on the mobile computing device based on the location of the mobile computing device and the wireless devices present and/or available for connection in the location. When the optimal preferences have been returned from the database, these preferences are communicated to the appropriate software applications running on the mobile computing device.

To carry out the exemplary method described above, the mobile computing device may host a digital computer program that includes appropriate modules for executing the requisite instructions for performing the operational steps of the method: (a) a location determination module for receiving data concerning a location of the mobile computing device; (b) a radio management module for receiving data about each wireless device present and/or available for connection in the location; (c) an analysis module for querying the first database to ascertain optimal user preferences for the one or more software applications running on the mobile computing device based on the location of the mobile computing device and the wireless devices present and/or available for connection in the location; and (d) an application interface for communicating instructions to one or more software applications for changing the user preferences associated with each software application to the optimal user preferences.

As an additional refinement, a further module can be incorporated into the method and system of the present invention for monitoring one or more software applications on the mobile computing device to identify changes to user preferences which are manually implemented. Upon identification of a change to user preferences, that change is stored in a second database, along with the location of the mobile computing device and the wireless devices present and/or available for connection to the mobile computing device at the time of each change. Then, there is a periodic review of the changes to user preferences stored in the second database to identify patterns of changes based on the mobile computing device being in a particular location or on a particular combination of wireless devices present and/or available for connection to the mobile computing device. Based on the identification of such patterns of changes, the first database is then updated.

### DESCRIPTION OF THE DRAWINGS

FIG. 1 is a flow chart illustrating an exemplary method for managing user preferences for one or more software applications running on a mobile computing device; and

FIG. 2 is a schematic representation of a mobile computing device, including the appropriate modules for executing the requisite instructions for performing the operational steps of the method illustrated in FIG. 1.

### DETAILED DESCRIPTION OF THE INVENTION

The present invention is a computer-based method and system for managing user preferences for one or more software applications running on a mobile computing device.

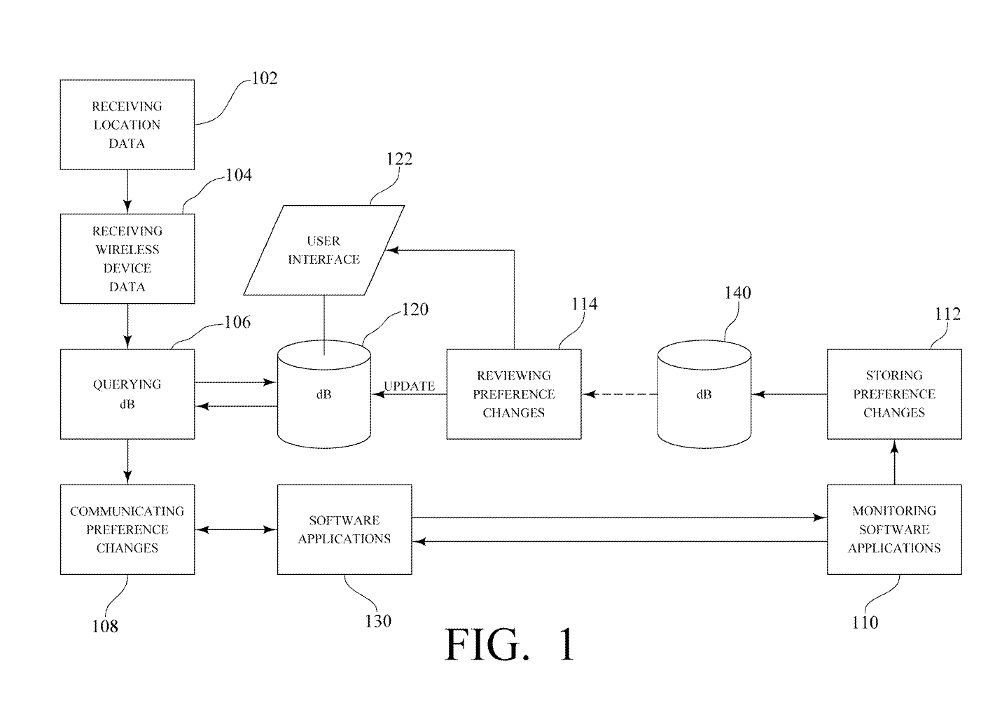

FIG. 1 is a flow chart illustrating an exemplary method for managing user preferences for one or more software applications running on a mobile computing device in accordance with the present invention. As will become clear in the description that follows, the operational steps of this method are preferably achieved through the use of a digital computer program, i.e., computer-readable instructions stored and executed by a computer. Accordingly, the mobile computing device hosts a digital computer program stored on a computer-readable medium that includes appropriate modules for executing the requisite instructions. Such instructions can be coded into a computer-readable form using standard programming techniques and languages, and with benefit of the following description, such programming is readily accomplished by one of ordinary skill in the art.

Referring still to FIG. 1, the method commences with a mobile computing device (such as a laptop computer) receiving data concerning a location of the mobile computing device, as indicated by step 102. The mobile computing device further receives data from one or more wireless devices present and/or available for connection in the location, as indicated by step 104. Such data would generally include identifying information, such as: (a) the type of radio (Bluetooth®, 802.11, etc.); (b) the unique identifier of the radio (BD_ADDR for Bluetooth®, SSID for 802.11, etc.); and (c) signal strength information. (Bluetooth® is a registered trademark of Bluetooth Sig, Inc. of Bellevue, Wash.) Furthermore, these two steps may be interconnected, in that the data received from the one or more wireless devices present and/or available for connection in the location may allow the mobile computing device to infer its location based on what wireless devices it “sees” in that location. A detailed discussion of inferring location in this manner can be found in co-pending and commonly assigned U.S. patent application Ser. No. 11/969,274, entitled “Method and System for Inferring a Location of a Mobile Computing Device” and filed on Jan. 4, 2008, which is incorporated herein by reference.

Furthermore, it should be recognized that there is a distinction between wireless devices present in a location and wireless devices that are available for connection in a given location. For example, the mobile computing device may receive data from and identify an access point to a secure network in a particular location, but without an appropriate security key or password, the mobile computing device can not connect to that access point. For purposes of the present invention, it is still helpful to know that the access point is present, even if it is not available for connection because it serves to identify and distinguish the current location of the mobile computing device.

Referring still to FIG. 1, after the mobile computing device has received data concerning the location of the mobile computing device and from one or more wireless devices present and/or available for connection in the location, the next step is to query a first database 120 to ascertain optimal user preferences for one or more software applications running on the mobile computing device based on the location of the mobile computing device and the wireless devices present and/or available for connection in the location, as indicated by step 106.

The first database 120 can store various types of user preferences for a wide range of software applications, including operating system software. For example, preferences for instant messaging software running on the mobile computing device, including which users can be engaged, can be established and implemented based on the location of the mobile computing device. For another example, with respect to the operating system software, user preferences that can be established and implemented based on the location of the mobile computing device and the wireless devices present and/or available for connection in the location include, but are not limited to: (a) Transmission Control Protocol (TCP) network settings; (b) default printer; (c) mapped file systems; (d) wireless security settings; (e) networking security settings; and/or (f) file sharing settings. For instance, focusing specifically on the TCP network settings, the first database 120 could store relevant user preferences with respect to: (i) whether or not to use Dynamic Host Configuration Protocol (DHCP); (ii) if not, the appropriate settings for the netmask, address, and gateway; (iii) whether or not the Domain Name Server (DNS) is assigned by DHCP; and (iv) if not, the appropriate identification of the DNS servers.

In this exemplary implementation of the method and system of the present invention, each preference is assigned and stored in the database 120 with a unique identifier. For example, Table A provides two different TCP network settings, with the unique identifiers P1 and P2:

TABLE A

| P1 | P2 |
|---|---|
| DHCP | No DHCP |
| Automatic DNS assignment | Netmask: 255.255.255.0 |
| | Address: 192.168.213.100 |
| | Gateway: 192.168.213.1 |
| | DNS1: 74.234.1.2 |
| | DNS2: 74.234.1.5 |

The database 120 would then also store the appropriate mapping between each preference and the triggers for each preference, i.e., a location of the mobile computing device, the wireless devices present, or the wireless devices available for connection. Since each location and wireless device also has a unique identification, a canonical preference trigger identification may be created, for example, by concatenating a 1 for a location, a 2 for a present wireless device, and a 3 for a wireless device available for connection. If there were two different locations and three wireless devices, the preference triggers may be as follows:

TABLE B

| | |
|---|---|
| Location 1 | 1_1 |
| Location 2 | 1_2 |
| Wireless Device 1 Present | 2_1 |
| Wireless Device 2 Present | 2_2 |
| Wireless Device 3 Present | 2_3 |
| Wireless Device 1 Connected | 3_1 |
| Wireless Device 2 Connected | 3_2 |
| Wireless Device 3 Connected | 3_3 |

Therefore, with respect to the querying of the database 120, as indicated by step 106, each preference trigger is representative of a location of the mobile computing device, the wireless devices present, or the wireless devices available for connection, and therefore, querying the database 120 using one or more preference triggers will return the optimal preferences stored in the database and associated with the particular preference trigger or a set of preference triggers. Returning to Table A, for purposes of example, trigger 3_2 (wireless device 3 connected) may be associated with the set of preferences P1, so when the preference trigger 3_2 is passed to the database 120, the set of preferences P1 will be returned. Similarly, when the preference trigger 3_3 is passed to the database 120, the set of preferences P2 will be returned

Returning to the flow chart of FIG. 1, when the optimal preferences have been returned from the database 120, these preferences are communicated to the appropriate software applications 130 running on the mobile computing device, as indicated by step 108. For example, with respect to the TCP network settings, the optimal preferences would typically be communicated to the operating system so that the changes to the preferences could be implemented.

As a further refinement, one of two trigger actions may be associated with each preference trigger or set of preference triggers—“trigger and hold” or “trigger while true.” In the example described above, when the preference trigger 3_2 is passed to the database 120, the set of preferences P1 is returned and implemented. If the “trigger and hold” action was associated with the preference trigger 3_2, the new settings will remain in effect even after the environment represented by preference trigger 3_2 has changed, for example, movement to a different location. If the “trigger while true” action was associated with the preference trigger 3_2, the settings would be returned to the prior state as soon as the environment represented by preference trigger 3_2 had changed.

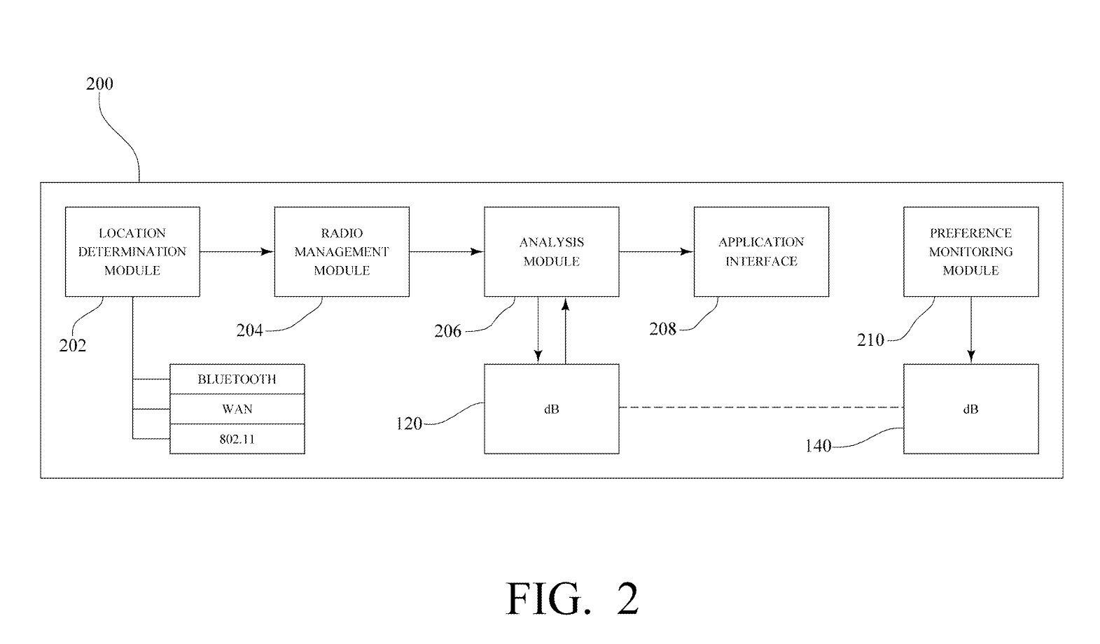

FIG. 2 illustrates the core components of an exemplary system for carrying out the method described above. The mobile computing device 200, such as a laptop computer, has a Bluetooth® radio, a WAN radio, and an 802.11 radio. The mobile computing device 200 hosts a digital computer program that includes appropriate modules for executing the requisite instructions for performing the operational steps of the method: (a) a location determination module 202 for receiving data concerning a location of the mobile computing device 200; (b) a radio management module 204 for receiving data about each wireless device present and/or available for connection in the location; (c) an analysis module 206 for querying the first database 120 to ascertain optimal user preferences for the one or more software applications running on the mobile computing device 200 based on the location of the mobile computing device 200 and the wireless devices present and/or available for connection in the location; and (d) an application interface 208 for communicating instructions to one or more software applications for changing the user preferences associated with each software application to the optimal user preferences.

With respect to FIGS. 1 and 2, it should be noted that preference triggers, optimal preferences, and trigger actions may be input into and stored in the first database 120 through a user interface 122 (FIG. 1). In other words, the user can manage preferences directly by assigning the optimal preferences that are associated with each preference trigger. Alternatively, a further module can be incorporated into the method and system of the present invention—a preference monitoring module 210 (FIG. 2), which monitors one or more software applications on the mobile computing device 200 to identify changes to user preferences which are manually implemented, as indicated by step 110 in FIG. 1.

Referring specifically to FIG. 1, upon identification of a change to user preferences, that change is stored in a second database 140, along with the location of the mobile computing device 200 and the wireless devices present and/or available for connection to the mobile computing device 200 at the time of each change, as indicated by step 112 in FIG. 1. Then, there is a periodic review of the changes to user preferences stored in the second database 140 to identify patterns of changes based on the mobile computing device 200 being in a particular location or on a particular combination of wireless devices present and/or available for connection to the mobile computing device, as indicated by step 114 in FIG. 1. Based on the identification of such patterns of changes, the first database 120 is then updated to add or revise the stored preference triggers. For example, a user may routinely change the default printer. After recognizing that such a change to the default printer was made each time the mobile computing device was transported to a particular location, this pattern of changing the default printer based on the mobile computing device 200 being in the particular location could lead to a preference trigger being stored in the first database 120 to effectuate the change of default printer automatically when the mobile computing device 200 is in that particular location. As an alternative, rather than directly storing the trigger and associated user preference in the first database 120, the suggested trigger and associated user preference could be first communicated to the user through the user interface 122 for approval of trigger and associated user preference.

Finally, as a further refinement, it is contemplated that the method and system of the present invention could be used not only for managing user preferences for one or more software applications running on the mobile computing device, but also for managing user preferences for one or more software applications running on a remote device that is connected to the mobile computing device. For example, and as discussed above with reference to FIG. 2, the mobile computing device may be a laptop computer that has a Bluetooth® radio, a WAN radio, and an 802.11 radio. The laptop computer hosts a digital computer program that includes appropriate modules for executing the requisite instructions for performing the operational steps of the method described above in order to ascertain optimal user preferences and communicate instructions to one or more software applications for changing the user preferences associated with each software application to the optimal user preferences. The user of the laptop computer also has a mobile telephone that can connect via its Bluetooth® radio to the laptop computer. Accordingly, the database 120 storing user preferences for software applications can also be used to store preferences for the mobile telephone, with those preference being communicated to the mobile telephone through the Bluetooth® radio connection. In other words, the mobile telephone does not need the complete digital computer program to carry out the method of the present invention, but can rely on the laptop computer to ascertain optimal user preferences and then communicate those optimal user preferences to the software applications hosted on the mobile telephone.

One of ordinary skill in the art will recognize that additional embodiments are also possible without departing from the teachings of the present invention or the scope of the claims which follow. This detailed description, and particularly the specific details of the exemplary implementation disclosed, is given primarily for clarity of understanding, and no unnecessary limitations are to be understood therefrom, for modifications will become obvious to those skilled in the art upon reading this disclosure and may be made without departing from the spirit or scope of the claimed invention.

What is claimed is:

1. A computer-based method for managing user preferences for one or more software applications running on a mobile computing device, comprising the steps of:
using the mobile computing device to receive data concerning a location of the mobile computing device;
using the mobile computing device to receive data about each wireless device present in the location, including those wireless devices that are available for connection;
querying a first database to ascertain optimal user preferences for the one or more software applications running on the mobile computing device based on the location of the mobile computing device and the wireless devices present and/or available for connection in the location; and
communicating instructions to one or more software applications for changing the user preferences associated with each software application to the optimal user preferences.

2. The computer-based method as recited in claim 1, and further comprising the steps of:
monitoring one or more software applications on the mobile computing device to identify changes in user preferences which are manually implemented;
storing each identified change to user preferences in a second database, along with the location of the mobile computing device and the wireless devices present in the location, including those wireless devices that are available for connection, at the time of each identified change;
reviewing changes to user preferences stored in the second database to identify patterns of changes based on the mobile computing device being in a particular location or on a particular combination of wireless devices present and/or available for connection to the mobile computing device; and
updating the optimal user preferences stored in the first database based on the identified patterns.

3. The computer-based method as recited in claim 1, in which a preference trigger is created based on the location of the mobile computing device, the wireless devices present in the location, the wireless devices available for connection in the location, or a combination thereof.

4. The computer-based method as recited in claim 3, wherein said optimal user preferences are returned in response to the querying of said first database with a particular preference trigger.

5. The computer-based method as recited in claim 3, in which a trigger action is associated with each preference trigger.

6. The computer-based method as recited in claim 5, in which the preference trigger causes the optimal user preferences to remain in effect even after a change in the location of the mobile computing device, the wireless devices present in the location, or the wireless devices available for connection in the location.

7. The computer-based method as recited in claim 5, in which the preference trigger causes the optimal user preferences to return to a prior state after a change in location of the mobile computing device, the wireless devices present in the location, or the wireless devices available for connection in the location.

8. A computer-based method for managing user preferences for one or more software applications running on a mobile computing device, comprising the steps of:
using the mobile computing device to receive data about each wireless device present in a given location, including those wireless devices that are available for connection in the given location;
querying a first database to ascertain optimal user preferences for the one or more software applications running on the mobile computing device based on the wireless devices present in the given location or the wireless devices available for connection in the given location; and
communicating instructions to one or more software applications for changing the user preferences associated with each software application to the optimal user preferences.

9. The computer-based method as recited in claim 8, and further comprising the steps of:
monitoring one or more software applications on the mobile computing device to identify changes in user preferences which are manually implemented;
storing each identified change to user preferences in a second database, along with the wireless devices present in the location, including those wireless devices available for connection to the mobile computing device, at the time of each identified change;
reviewing changes to user preferences stored in the second database to identify patterns of changes based on a particular combination of wireless devices present and/or available for connection to the mobile computing device; and
updating the optimal user preferences stored in the first database based on the identified patterns.

10. The computer-based method as recited in claim 8, in which the first database is queried to ascertain the optimal user preferences for certain Transmission Control Protocol (TCP) network settings.

11. The computer-based method as recited in claim 10, in which the optimal user preferences for the Transmission Control Protocol (TCP) network settings include (i) whether or not to use Dynamic Host Configuration Protocol (DHCP); (ii) if not, appropriate settings for a netmask, address, and gateway; (iii) whether or not a Domain Name Server (DNS) is assigned by DHCP; and (iv) if not, an appropriate identification of DNS servers.

12. The computer-based method as recited in claim 8, in which the first database is queried to identify a default printer.

13. The computer-based method as recited in claim 8, in which the first database is queried to ascertain the optimal user preferences for certain wireless security settings.

14. The computer-based method as recited in claim 8, in which the first database is queried to ascertain the optimal user preferences for certain networking security settings.

15. The computer-based method as recited in claim 8, in which the first database is queried to ascertain the optimal user preferences for certain file sharing settings.

16. The computer-based method as recited in claim 8, in which the software application running on the mobile computing device is instant messaging software.

17. A computer-based method for managing user preferences for one or more software applications running on a remote device connected to a mobile computing device, comprising the steps of:
using the mobile computing device to receive data about each wireless device present in a given location, including those wireless devices that are available for connection in the given location;
querying a first database to ascertain optimal user preferences for the one or more software applications running on the remote device connected to the mobile computing device based on the wireless devices present in the given location or the wireless devices available for connection in the given location; and
communicating instructions to one or more software applications running on the remote device connected to the mobile computing device for changing the user preferences associated with each software application to the optimal user preferences.

18. A computer-based system for managing user preferences for one or more software applications running on a mobile computing device, comprising:
a location determination module resident on a computer-readable medium of the mobile computing device for receiving data concerning a location of the mobile computing device;
a radio management module resident on the computer-readable medium of the mobile computing device for receiving data about each wireless device present and/or available for connection in the location;
an analysis module resident on the computer-readable medium of the mobile computing device for querying a first database to ascertain optimal user preferences for the one or more software applications running on the mobile computing device based on the location of the mobile computing device and the wireless devices present and/or available for connection in the location; and
an application interface for communicating instructions to the one or more software applications for changing the user preferences associated with each software application to the optimal user preferences.

19. The computer-based system as recited in claim 18, and further comprising:
a preference monitoring module for monitoring one or more software applications on the mobile computing device to identify changes in user preferences which are manually implemented.

20. The computer-based system as recited in claim 19, in which each identified change in user preferences is stored in a second database, along with the location of the mobile computing device and the wireless devices present and/or available for connection to the mobile computing device at the time of each identified change, with such stored changes to user preferences being periodically reviewed to identify patterns of changes, and then updating the optimal user preferences stored in the first database based on the identified patterns.
